(19) United States
(12) Patent Application Publication
(10) Pub. No.: US 2009/0049425 A1
(43) Pub. Date: Feb. 19, 2009

(54) Code Obfuscation By Reference Linking

(75) Inventors: Martin Liepert, Tel Aviv (IL); Vitali Yauseyanka, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ALADDIN KNOWLEDGE SYSTEMS LTD., Tel Aviv (IL)

(21) Appl. No.: 11/838,247

(22) Filed: Aug. 14, 2007

(51) Int. Cl. G06F 9/44

(52) U.S. Cl. 717/110

(57) ABSTRACT

A method of obfuscating executable computer code to impede reverse-engineering, by interrupting the software's execution flow and replacing in-line code with calls to subroutines that do not represent logical program blocks. Embodiments of the present invention introduce decoy code to confuse attackers, and computed branching to relocated code so that actual program flow cannot be inferred from disassembled source representations.

### FIELD OF THE INVENTION

The present invention relates to computer software rights management, and, more particularly, to a method of obfuscating computer code for protection against reverse-engineering attacks.

### BACKGROUND OF THE INVENTION

Because computers are typically open systems, computer software is vulnerable to reverse-engineering. For software rights management, however, it is desirable to protect certain sections of code against debugging and reverse-engineering.

Compilers and assemblers usually generate predictably regular executable code which is relatively easy for a skilled attacker to reverse-engineer. The term “reverse-engineering” herein denotes any process for deriving human-meaningful source code (including, but not limited to: assembler source code and compiler source code) from machine-executable software. With reverse-engineered source code, an attacker can easily excerpt and/or edit the code for reassembling/recompiling into modified software based on the original software, thereby violating the proprietary rights of the original developers.

The term “obfuscation” herein denotes any process of altering executable code to increase the difficulty of reverse-engineering by confusing the attacker, by disabling reverse-engineering tools such as disassemblers and decompilers, and/or by causing the reverse-engineering process to output erroneous, defective, or non-usable source code so that the reassembly/recompiling process fails or outputs non-functional software. It is generally recognized that obfuscation does not provide true security, but when suitably deployed, good obfuscation can render the reverse-engineering process too time-consuming and expensive for the attackers to justify, or at least can delay the success of reverse-engineering.

There is thus a widely recognized need for, and it would be highly advantageous to have, an additional means of efficiently obfuscating computer software code. This goal is met by the present invention.

### SUMMARY OF THE INVENTION

The present invention is of a method for obfuscating code by interrupting the software's execution flow and replacing in-line code with calls to subroutines that do not represent logical program blocks. According to embodiments of the present invention, obfuscation is done by relocating code fragments out of the normal program flow to different locations, and linking references to the fragments from their original locations. By suitably selecting candidate fragments for relocation and reference linking according to embodiments of the present location, it is possible to increase the efficiency of obfuscation without imposing undue processing burdens when executing the software. According to other embodiments of the present invention, it is possible to minimize the inflation of the executable code space. In addition, according to further embodiments of the present invention, it is possible to introduce additional occurrences of obfuscation which have little or no effect on the software performance.

In embodiments of the present invention, reference linking is accomplished via subroutine calls.

Therefore, according to the present invention there is provided a method for obfuscating executable computer code which derives from assembler source instructions, the method including: (a) breaking the assembler source instructions into a plurality of fragments, and entering each fragment of the plurality of fragments into a fragment database; (b) examining each of the plurality of fragments and excluding a fragment from the fragment database if at least one of the following conditions occurs: [i] the fragment has a fragment size smaller than a predetermined minimum fragment size; [ii] the fragment contains stack-pointer modification instructions; [iii] the fragment contains a branching instruction to a relative address outside the fragment; [iv] assembler source instructions contain a branching instruction into the fragment from outside the fragment; (c) for each fragment remaining in the fragment database: [v] making a copy of the fragment in an area of program space of the assembler source instructions and appending a return instruction thereto; [vi] replacing the fragment in the assembler source instructions with a call to the copy, followed by a jump; and (d) assembling the assembler source instructions into obfuscated executable code.

### BRIEF DESCRIPTION OF THE DRAWINGS

The invention is herein described by way of example only, with reference to the accompanying drawings, wherein:

FIG. 1 conceptually illustrates obfuscation of executable code according to an embodiment of the present invention.

FIG. 2 is a flowchart of a method for building a fragment database according to certain embodiments of the present invention.

FIG. 3 is a flowchart of a method for relocating fragments and obfuscating executable code thereby, according to certain embodiments of the present invention.

### DESCRIPTION OF THE PREFERRED EMBODIMENTS

The principles and operation of a method for obfuscating executable code according to the present invention may be understood with reference to the drawings and the accompanying description.

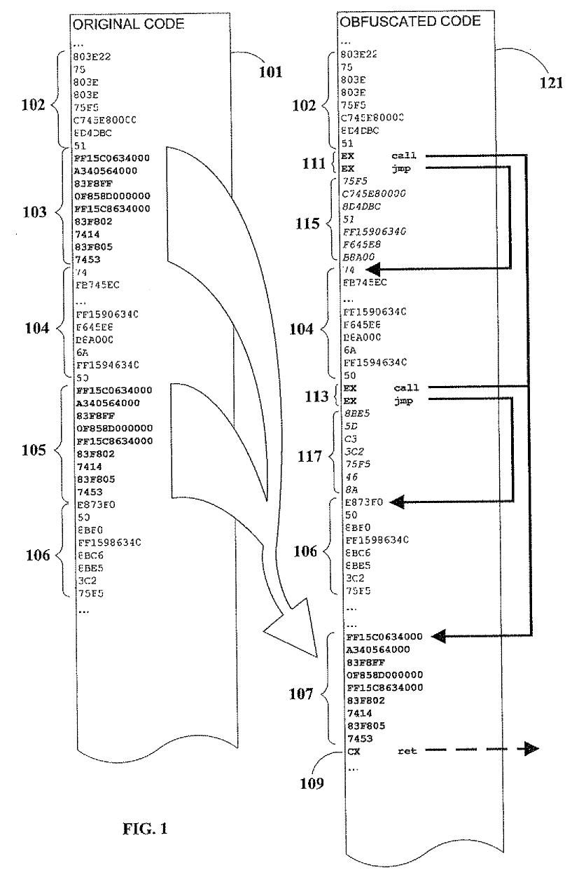

FIG. 1 conceptually illustrates obfuscation of (a section of) original executable code 101 according to an embodiment of the present invention. Executable code 101 is herein conceptually represented as a sequence of hexadecimal digits.

Executable code 101 typically derives from source code, such as assembler source instructions or compiler source statements. Without loss of generality, executable code 101 can always be considered to derive from assembler source instructions. If an original assembler source does not exist, an assembler source can always be obtained such as by disassembling executable code 101 to obtain assembler source instructions from which executable code 101 can be derived. Therefore, the term “assembler source instructions” herein denote such assembler code from which executable code 101 can be derived, whether or not executable code 101 was originally obtained by assembly of the assembler source instructions, as opposed to some other source (such as by being compiled from a compiler source).

Original code 101 is Original executable code 101 can be logically divided into fragments (also sometimes denoted as “blocks”)—fragments 102, 103, 104, 105, and 106 by noting that fragments 103 and 105 (in bold-face type) comprise identical code sequences. Fragments 102, 104, and 106 (in regular face type) are fragments of code occurring before, between, and after fragments 103 and 105 and comprise different code sequences. Original executable code 101 is also referred to as “binary machine code”, distinct from human-readable “source code” in assembly language or a higher-level language. Original executable code 101 is also denoted as the “object code” output from an assembler or compiler, suitably linked if necessary, and in a form ready to be executed on a computer.

In FIG. 1 is also shown a corresponding (section of) obfuscated executable code 121 corresponding to original executable code 101. The term “corresponding to” herein denotes that obfuscated executable code 121 has exactly the same functional behavior when executed as does original executable code 101. The executed behavior is absolutely identical, ignoring negligible timing differences on account of certain jumps and calls, as detailed below. These timing differences are negligible in comparison to the timing variations ordinarily-encountered when executing computing software in a multi-tasking or multi-user operating system platform, or on a processor that handles interrupts. Other than such negligible timing differences, the functional computational behavior of obfuscated executable code 121 is identical to that of original executable code 101′ as discussed below.

As shown in FIG. 1, fragments 102, 104, and 106 also appear in obfuscated executable code 121 in their respective locations. Fragments 103 and 105, however, have been removed, and a fragment 107 having identical code appears in a new location within obfuscated executable code 121. Appended to fragment 107 is a “return from subroutine” instruction ret 109. In addition, in place of fragment 103 are two instructions 111—a “call subroutine” instruction call, which makes a subroutine call to the code of fragment 107, and a “jump” instruction jmp, which jumps to the instruction at the beginning of fragment 104 after fragment 107 returns from ret 109, thereby skipping over the rest of the fragment 115. It can thus be seen that obfuscated executable code 121 executes exactly as if fragment 103 were present, but without fragment 103. Likewise, in place of fragment 105 are two instructions 113—a “call subroutine” instruction call, which makes a subroutine call to the code of fragment 107, and a “jump” instruction jmp, which jumps to the instruction at the beginning of fragment 106 after fragment 107 returns from ret 109, thereby skipping over a fragment 117. In a like manner, obfuscated executable code 121 executes exactly as if fragment 105 were present, but without fragment 105.

Code such as instructions 111, 113, and 109 are represented as assembler source instructions for conceptual clarity in presentation, it being appreciated by those skilled in the art that binary or hexadecimal representations thereof actually appear in obfuscated code 121.

The above substitutions introduce a level of obfuscation in the code, because fragment 107 is, strictly speaking from a programming standpoint, not a subroutine in the true sense, in that the normal structure of a typical subroutine is absent. According to embodiments of the present invention, fragments 103 and 105 were selected for this substitution operation solely by virtue of being similar code sequences with specified properties, as detailed below. From a higher-level programming standpoint, therefore, it is highly likely that fragment 107 makes no logical sense as a subroutine and is therefore likely to be confusing to an attacker trying to interpret the logical purpose of such a fragment in the context of the software program.

Further obfuscation can be introduced:
According to another embodiment of the present invention, non-functional decoy code can be placed in fragments 115 and 117. Criteria for the selection of fragments 103 and 105 (as detailed below) guarantee that code in this area is never executed. Consequently code in fragments 115 and 117 can be introduced to further confuse the attacker.
According to yet another embodiment of the present invention (herein denoted as an “interleaving” embodiment), additional relocated executable fragments (comparable in scheme to fragment 107) can be placed in fragments 115 and 117, provided that such fragments are small enough to fit therein.

According to a further embodiment of the present invention, one or both of the call and jmp instructions of fragments 111 and 113 are conditional (depending on the instruction set in use), which in theory are not always executed, but which in practice are based on tests which are set up to always be executed. For example a “jump on zero” instruction jz can depend on the value of a specified register, which is set by the altered code to always be zero. During disassembly, however, the instruction is interpreted as being conditional, which means that the code following the conditional jump will be considered valid and will be disassembled.
According to yet a further embodiment of the present invention, one or both of the call and jmp instructions of fragments 111 and 113 are to computed addresses (depending on the instruction set in use), which are determined at runtime rather than being in the code as literal addresses. This creates additional levels of obfuscation, because a disassembler does not know the computed addresses and therefore cannot associate call/jump 111 with fragment 107.

It is noted that the above obfuscations cannot stop a determined and skilled attacker, who executes the software using a suitable debugger (such as a hardware debugger) to discover the actual run-time flow of the program. However, such measures can substantially increase the difficulty of reverse-engineering.

### Building Fragment Database

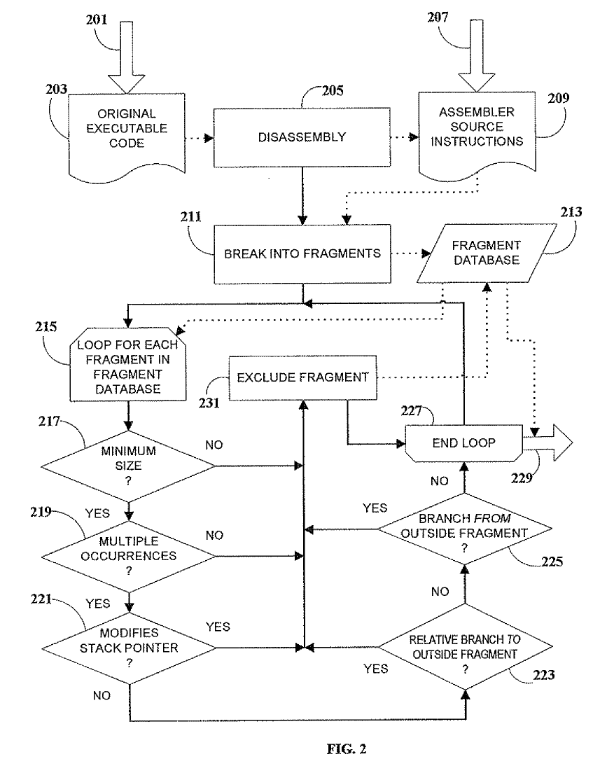

FIG. 2 is a flowchart of a method according to certain embodiments of the present invention for building a fragment database 213. In an embodiment of the present invention, the method starts at an entry point 201 with original executable code 203, which is first disassembled in a step 205 and results in a stored sequence of (reverse-engineered) assembler source instructions 209. In another embodiment of the present invention, the method starts at an entry point 207 where sequence of assembler source instructions 209 is already available without disassembly. This alternative embodiment is typically used when original executable code 203 is assembled from assembler source code, and the original assembler source code is available for use as assembler source instructions 209.

The term “fragment” herein denotes any set of contiguous assembler-language code containing at least one valid and complete assembler instruction, which may contain one or more parameters and/or arguments (such as addressing), and which can be assembled into valid executable machine code (such as that contained in original executable code 203, for embodiments of the present invention beginning with original executable code 203). It is further noted that the term “fragment” herein denotes assembler code in the form of standard assembler instructions, not machine code, which is typically in binary form.

In a step 211, assembler source instruction sequence 209 is broken into candidate fragments, which are individually stored in fragment database 213 along with the location in assembler source instruction sequence 209 where each individual fragment appears. The term “fragment database” herein denotes any collection of fragments, in which a fragment (or equivalently, a representation thereof) can be stored, in which a stored fragment can be associated with additional data, from which a stored fragment can be deleted or excluded, which can be searched for a stored fragment based on one or more criteria, and from which a stored fragment can be retrieved. The term “candidate fragment” herein denotes a fragment which is not yet determined to be suitable for relocation. Candidate fragments in fragment database 213 are therefore subsequently screened, as detailed below.

After populating fragment database 213 with candidate fragments, in a loop starting at a start-of-loop point 215, each fragment in fragment database 213 is examined to determine suitability for relocation. According to embodiments of the present invention, suitable fragments for relocation as previously described are selected in keeping with the following criteria:
Minimum Size—At a decision point 217, candidate fragments are examined to determine if the assembled size thereof is at least the size of the assembled executable machine code call subroutine. The term “fragment size” herein denotes the size of the assembled executable code which derives from the fragment. On the x86 platform, this minimum size is 5 bytes. Candidate fragments which do not meet this criterion are excluded from fragment database 213 in a exclusion step 231.
After exclusion step 231, control passes to an end-of-loop point 227. If there are further fragments to examine, control resumes at the start-of-loop point 215. If there are no further fragments, however, end-of-loop point 227 terminates the method at an exit point 229, with fragment database 213 containing only fragments for relocation, as detailed below.
Multiple Occurrences—At a decision point 219, candidate fragments are examined to determine if the fragment occurs more than once in assembler instructions 209. A candidate fragment is said to occur more than once if a fragment which executes to perform the exact same function occurs in more than one place in assembler instructions 209. Instances of fragments which occur more than once are said to be “similar”. Candidate fragments which do not have similar fragments elsewhere in the assembly source instructions are excluded from fragment database 213 in exclusion step 231.
No Stack Pointer Modification—At a decision point 221, candidate fragments are examined to determine if the fragment contains stack-pointer modification instructions (e.g., push or pop instructions). Candidate fragments which do modify the stack pointer are excluded from fragment database 213 in exclusion step 231.
No Relative Branch to Outside Fragment—At a decision point 223, candidate fragments are examined to determine if the fragment contains a branching instruction to a relative address outside the fragment. Candidate fragments which do make branches to a relative address outside the fragment are excluded from fragment database 213 in exclusion step 231. (Branches to absolute addresses are acceptable, and branches to a relative address inside the fragment are also acceptable.) The term “branch” herein refers to any transfer of execution control to a new address, and includes both “jump” and “call” instructions.
No Calls from Outside the Fragment to Any Location within the Fragment—At a decision point 225, candidate fragments are examined to determine if a branch is made to the fragment from an address outside the fragment. Candidate fragments into which branching instructions are made from assembler source instructions outside the fragment are excluded from fragment database 213 in exclusion step 231. (Both absolute and relative branching from addresses outside the fragment are cause to exclude the fragment. Branching of any kind that stays within the fragment, however, is acceptable.)

It is appreciated by those skilled in the art that the above-described method steps involving database manipulation can be accomplished in alternate ways. For example, instead of deleting or excluding database entries which do not qualify, only qualifying entries can be copied to a new database, and so forth. The above embodiment is therefore presented as a non-limiting example. A preferred embodiment with optimized database efficiency is also presented below.

### Optimizing the Fragment Database

FIG. 2 and the above description illustrate how fragment database 213 is constructed and utilized in conceptual terms. In a preferred embodiment of the present invention, however, the efficiency may be optimized by compiling fragment database 213 to contain pointers to fragments in assembler source instructions 209, as opposed to copies of the fragments, as illustrated conceptually above. Pointers according to this preferred embodiment are address pointers to the beginnings of potential fragments. It is noted that pointers are typically to the beginnings of assembler opcodes.

Preliminary optimization can be performed on the pointer locations themselves. For example, some opcodes are disqualified by the foregoing criteria, including, but not limited to: ret; push; and pop. Therefore, fragment database 213 automatically excludes pointers to such locations.

In this preferred embodiment, searching for identical code sequences in fragments of assembler source instructions 209 is thus done by reference, by successively comparing a first pointer's references to a second pointer's references as they are both successively offset by the same amount. Let p represent the first pointer, and q represent the second pointer. Let p [0] represent the contents of the base location to which p points, and q[0] likewise represent the contents of the base location to which q points. Let p [i] and q[i] then represent the contents of their respective base locations when offset by the positive integer i. If p[i]=q[i] for i=1, 2, . . . n, then p and q point to identical fragments of length n+1.

When identical fragments are located, as described above, the length of the code fragment (n+1 in the above illustration) is stored in fragment database 213 along with the applicable base pointers p and q in the above illustration). This optimizes fragment database 213 by storing only a compact representation of the code fragments, rather than copies of the code fragments themselves.

The previously-presented criteria are used to assure that only acceptable code fragments are stored in fragment database 213, as illustrated in FIG. 2. It is noted, however, that searching for multiple occurrences of code fragments in decision point 219 has already been done by the foregoing comparison loop that tests to see if p[i]=q[i] for i=1, 2, . . . n.

Fragment database 213 according to this preferred embodiment of the present invention is logically equivalent to that of the earlier-present embodiment illustrating fragment database 213 conceptually. Accordingly, it can be appreciated by those skilled in the art that fragment database 213 can be treated the same regardless of whether the data therein is in the form of fragments, copies of fragments, or pointers to fragments.

Specifically, the term “entering a fragment into a fragment database” (along with grammatical variants thereof) herein denotes any of the following actions:
putting the code fragment into the fragment database;
putting a copy of the code fragment into the fragment database;
putting a pointer to the code fragment into the fragment database.

Similarly, the term “excluding a fragment from a fragment database” (along with grammatical variants thereof) herein denotes any of the following actions:
not entering the code fragment into the fragment database (as defined above);
deleting the code fragment from the fragment database;
deleting a copy of the code fragment into the fragment database;
deleting a pointer to the code fragment into the fragment database.

### Relocating Fragments

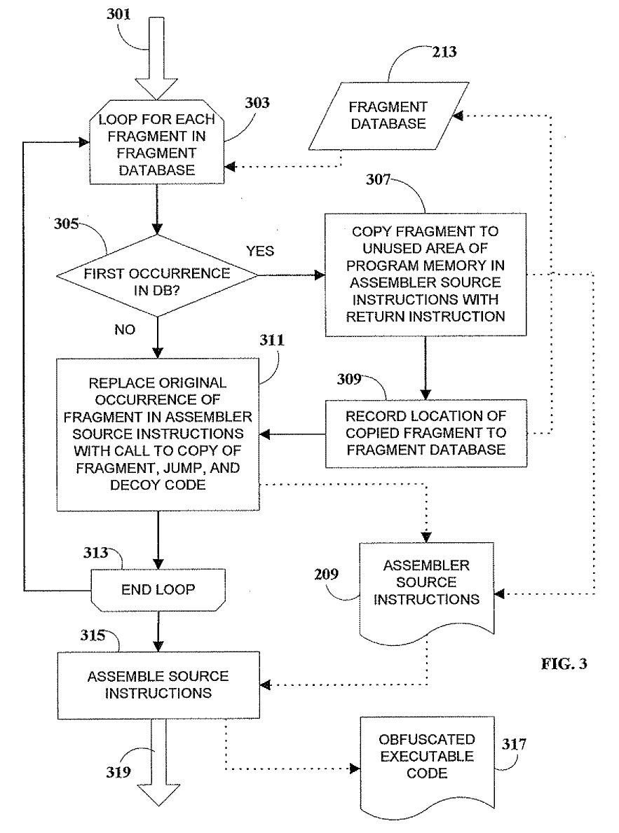

FIG. 3 is a flowchart of a method for relocating fragments and obfuscating executable code thereby, according to certain embodiments of the present invention. Starting at an entry point 301, the method takes fragment database 213 as built by the steps previously detailed and illustrated in FIG. 2. Then at a loop starting point 303, each fragment stored in fragment database 213 is examined. At a decision point 305, if the examined fragment is the first occurrence of the fragment in fragment database 213, then in a copying step 307 the fragment is copied to an unused area of program space in assembler source instructions 209 (from FIG. 2), along with a return instruction (in a non-limiting example: CX ret) 109 as previously discussed and presented in FIG. 1. Then, in a step 309 the location of the copied fragment in assembler source instructions 209 is recorded in fragment database 213 for future reference. Subsequently, in a step 311, the original occurrence of the fragment in assembler source instructions 209 is replaced with a call (in a non-limiting example: EX call) followed by a jump (in a non-limiting example: EX jmp) 111 (FIG. 1). In an embodiment of the present invention, in step 311 the rest of the code of the relocated fragment is replaced by decoy code 115 (FIG. 1). At an end-of-loop point 313, if there are more fragments in fragment database 213, the loop is repeated from point 303. It is recalled that one of the criteria for fragment selection is that the fragment occur multiple times in assembler source instructions 209. Thus, the fragment will be encountered in the fragment database again. On subsequent occurrences, decision point 305 branches directly to step 311. FIG. 1 illustrates subsequent fragment replacement with a call (in a non-limiting example: EX call) followed by a jump (in a non-limiting example: EX jmp) 113 and decoy code 117.

When all fragments in fragment database 213 have been handled, end-of-loop 313 is followed by an assembly step 315 in which the modified assembler source instructions 209 is assembled into obfuscated executable code 317, after which the method completes at an exit point 319.

Differences from Compression Methods

There are superficial likenesses between the method of the present invention and prior art compression methods, such as the Lempel-Ziv compression algorithm, in that such compression schemes replace occurrences of data fragments with references to previously-encountered identical data fragments, in a manner comparable to the replacement of code fragments in the present invention. It will be appreciated by those skilled in the art, however, that there are significant differences between the method of the present invention and compression schemes. First of all, according to the present invention, the resulting obfuscated code executes exactly in the same manner as the original executable code without any decompression operation. Secondly, there are additional requirements (as previously discussed) on fragment selection imposed by the present invention which have no counterpart in compression algorithms.

### Embodiment Variations

As previously noted, in an embodiment of the present invention, a branch (such as a call or jump) can be computed rather than literal, so that a disassembler will not indicate the actual program flow.

Moreover, in another embodiment of the present invention, expansion of assembler source instructions 209 is minimized by having step 307 copy a small fragment into the unused code area of a previously-relocated larger fragment (in place of decoy code). This process is herein denoted as interleaving of fragments. In a related embodiment, fragment database 213 is sorted in order of descending fragment size to facilitate this particular embodiment.

In a further embodiment of the present invention, fragments are considered similar if they have identical program action when assembled into executable code, even though their code may exhibit superficial non-functional differences, such as in the order of instruction execution. A non-limiting example of this is as follows;

A first fragment is
mov eax,edx
mov ebx,ecx
add edx,[ecx+edx]
xor ebx,eax

and a second fragment is
mov ebx,ecx
mov eax edx
add edx,[ecx+edx]
xor ebx,eax

It can readily be seen that these two fragments are not literally identical, in that their first two lines are in different order. However, the programmatic effects of these two fragments are completely identical, and therefore they are similar for purposes of the present invention, and in this further embodiment are stored in fragment database 213 as similar fragments.

While the invention has been described with respect to a limited number of embodiments, it will be appreciated that many variations, modifications and other applications of the invention may be made.

1. A method for obfuscating executable computer code which derives from assembler source instructions, the method comprising:
breaking the assembler source instructions into a plurality of fragments, and entering each fragment of said plurality of fragments into a fragment database;
examining each of said plurality of fragments and excluding a fragment from said fragment database if at least one of the following conditions occurs:
said fragment has a fragment size smaller than a predetermined minimum fragment size;
said fragment contains stack-pointer modification instructions;
said fragment contains a branching instruction to a relative address outside the fragment;
assembler source instructions contain a branching instruction into said fragment from outside said fragment;
for each fragment remaining in said fragment database:
making a copy of said fragment in an area of program space of the assembler source instructions and appending a return instruction thereto;
replacing the fragment in the assembler source instructions with a call to said copy, followed by a jump; and
assembling the assembler source instructions into obfuscated executable code.

2. The method of claim 1, wherein a fragment is further excluded from said fragment database if said fragment does not have similar fragments elsewhere in said fragment database.

3. The method of claim 1, wherein said entering each fragment of said plurality of fragments into a fragment database comprises putting a pointer to a code fragment into said fragment database.

4. The method of claim 2, wherein said fragment has a similar fragment elsewhere in said fragment database if a fragment elsewhere in said fragment database is identical in assembler source instructions to said fragment.

5. The method of claim 2, wherein said fragment has a similar fragment elsewhere in said fragment database if a fragment elsewhere in said fragment database has identical has identical program action when assembled into executable code.

6. The method of claim 1, further comprising:
disassembling the executable computer code into assembler source instructions.

7. The method of claim 1, further comprising:
inserting decoy code into the assembler source instructions.

8. The method of claim 1, further comprising:
interleaving said copy in the assembler source instructions.

9. The method of claim 1, in which said call to said copy is a computed branch.

10. The method of claim 1, in which said jump is a computed branch.
